(19) United States
(12) Patent Application Publication
(10) Pub. No.: US 2013/0227440 A1
(43) Pub. Date: Aug. 29, 2013

(54) METHOD AND SYSTEM FOR CREATING USER EXPERIENCES BASED ON CONTENT INTENT

(71) Applicants: Suneel T. Chandra, Andhra Pradesh (IN); Ashootosh Chand, Bangalore Karnataka (IN)

(72) Inventors: Suneel T. Chandra, Andhra Pradesh (IN); Ashootosh Chand, Bangalore Karnataka (IN)

(73) Assignee: Yahoo! Inc., Sunnyvale, CA (US)

(21) Appl. No.: 13/407,101

(22) Filed: Feb. 28, 2012

(51) Int. Cl. G06F 3/01

(52) U.S. Cl. 715/760

(57) ABSTRACT

A system and method for generating and transmitting for display a web page according to user activity data. In one aspect, a server computer receives a request from a user operating a user computing device to serve a web page. The server computer retrieves stored user activity data of the user, the stored user activity data based on interests of the user derived from actions taken by the user on web pages previously viewed by the user. The server computer identifies, using the stored user activity data, web content likely of interest to the user. The server computer then dynamically generates, in response to the request, a user specific web page, the user specific web page comprising the identified web content.

### FIELD

The present disclosure relates to displaying a web page, and more specifically to a method and system for dynamically generating and displaying web pages according to a user's activity data.

### BACKGROUND

Web pages today are typically directed to a general audience. Users then navigate to specific sections of or links on the web page based on the user's interests. This general approach to web pages often results in the user having to perform more work to navigate to information that the user desires based on the user's preferences.

For example, a news web page is typically a web page that displays news stories on various subjects. If a user wants to view news stories related to sports (e.g., sports scores), the user typically has to click on a particular tab, icon, or graphic related to sports. The browser then navigates to the requested sports page so that the user can view the sports information that the user wants to see.

### SUMMARY

This disclosure relates to a system and method for generating and transmitting for display a web page according to user activity data. In one aspect, a server computer receives a request from a user operating a user computing device to serve a web page. The server computer retrieves stored user activity data of the user, the stored user activity data based on interests of the user derived from actions taken by the user on web pages previously viewed by the user. The server computer identifies, using the stored user activity data, web content likely of interest to the user. The server computer then dynamically generates, in response to the request, a user specific web page, the user specific web page comprising the identified web content. In one embodiment, the user action on a web page is selection of a part of, section of, or link on the web page.

The retrieving of the stored user activity data of the user can include receiving a cookie from the user computing device or determining the user activity data from a database. The retrieving of the stored user activity data of the user can include determining what the user has selected in a web page over a predetermined period of time (e.g., over the last few minutes, hours, days, weeks, etc.), determining a location of the user computing device, determining a time of day that the request for the web page was received, determining the age of the user, determining the gender of the user, and/or determining any other statistic or information associated with the user. In one embodiment, the dynamic generation of the user specific web page includes generating the user specific web page based on the location of the user, generating the user specific web page based on the time of day, and/or generating the user specific web page based on the gender or the age of the user.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a user computing device communicating with a server computer over a network in accordance with an embodiment of the present disclosure;

FIG. 2 is a flowchart illustrating steps performed by the server computer of FIG. 1 in accordance with an embodiment of the present disclosure;

FIG. 3 is an embodiment of an exemplary user interface screen of a web page displaying news;

FIG. 4 is an embodiment of an exemplary user interface screen of another web page displaying news;

FIG. 5 is an embodiment of an exemplary user interface screen of a user specific web page in accordance with an embodiment of the present disclosure;

FIG. 6 is an embodiment of an exemplary user interface screen of a user specific web page having a combination tab based on user activity data in accordance with an embodiment of the present disclosure; and

FIG. 7 is a block diagram illustrating an internal architecture of a computer in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. Fore example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

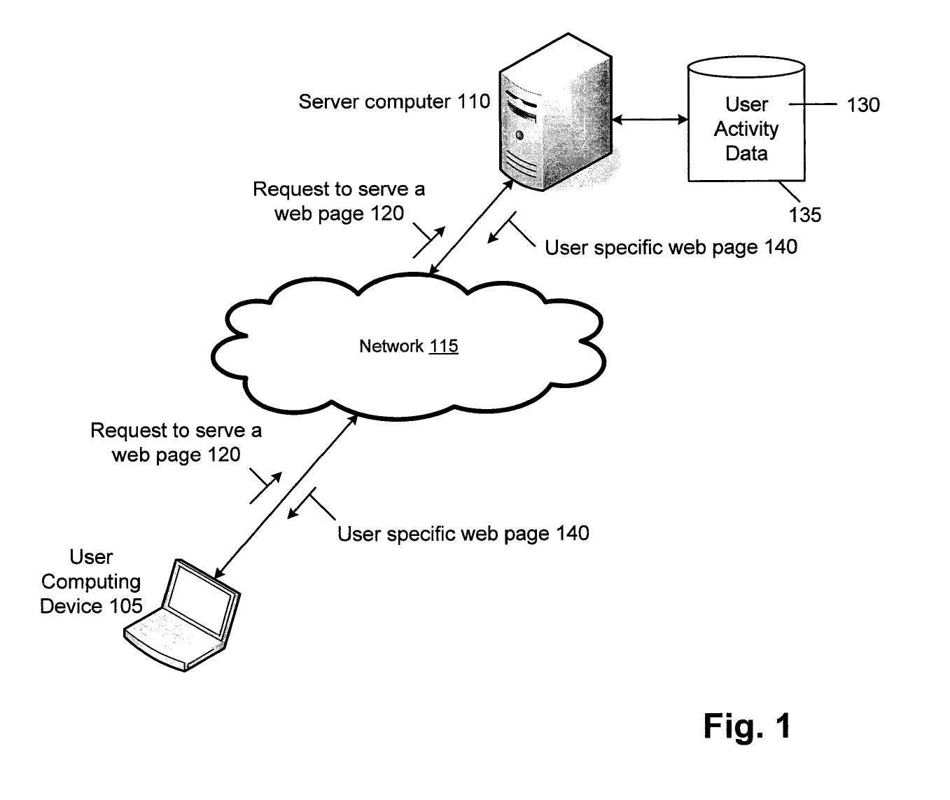

FIG. 1 is a block diagram of an embodiment of a user computing device 105 communicating with a server computer 110 over a network 115 such as the Internet. A user uses a browser on the user computing device 105 to navigate to one or more web pages on the Internet. In one embodiment, the server computer 110 collects user activity data of the user while the user browses the web. In one embodiment, user activity data of a user is past browser data for the user.

In one embodiment, the user submits a request 120 to serve a web page. The user computing device 105 transmits the request 120 to the server computer 110 over the network 115. In one embodiment, the server computer 110 determines user activity data 130 associated with the user from a database 135. In one embodiment, the user activity data is based on interests of the user derived from actions taken by the user on web pages previously viewed by the user (e.g., selecting a link on a web page). The database 135 may be internal to the server computer 110 or may be external to and in communication with the server computer 110. In one embodiment, the server computer 110 identifies, using the stored user activity data, web content likely of interest to the user. The server computer 110 then dynamically generates, in response to the request 120, a user specific web page 140, the user specific web page 140 including the identified web content (e.g., and not based on user settings for the web page input by the user).

A client device such as the user computing device 105 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example. A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Network 115 may couple devices so that communications may be exchanged, such as between a server and a client device or other types of devices, including between wireless devices coupled via a wireless network, for example. Network 115 may also include mass storage, such as network attached storage (NAS), a storage area network (SAN), or other forms of computer or machine readable media, for example. Network 115 may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

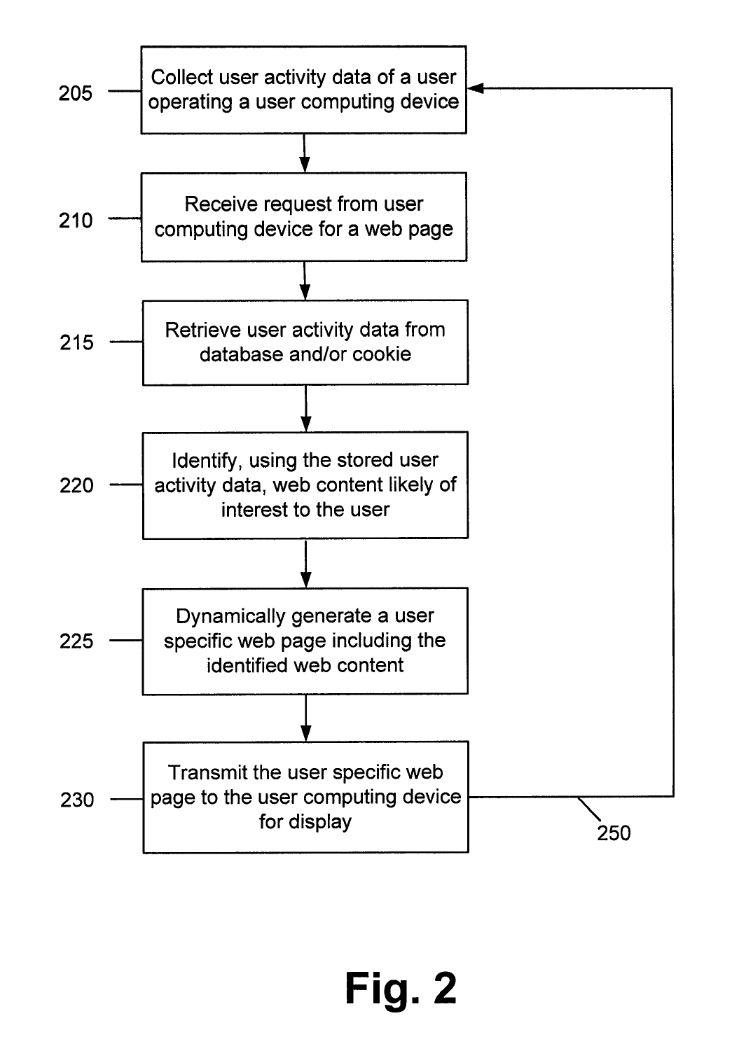

FIG. 2 is a flowchart of an embodiment of the steps performed by the server computer 110 to dynamically generate and transmit the user specific web page 140. In one embodiment, the server computer 110 (e.g., of a service provider, such as Yahoo!) collects (e.g., over a period of time) user activity data of a user operating the user computing device 105 (step 205). The user uses a browser to request a web page (e.g., www.yahoo.com) for display on the user computing device 105 (step 210). In one embodiment, the web page is a home page of a service provider (e.g., www.yahoo.com). In one embodiment, the user logs into the web page (e.g., by providing a username and password). In another embodiment, the web page is a landing page for a vertical property of a web site associated with the service provider, such as a news web page (e.g., www.news.yahoo.com) or a sports web page (e.g., www.sports.yahoo.com).

In one embodiment, the server computer 110 receives the user's login information and verifies the information. Once verified, the server computer 110 retrieves the user activity data 130 associated with the user. In one embodiment, the server computer 110 determines (e.g., retrieves) the user activity data from the database 135. Determining the user activity data 130 can include, for example, determining what the user has selected in a previously viewed web page over a predetermined period of time (e.g., over the past few minutes, hours, days, weeks, etc.), determining a location of the user computing device 105, determining a time of day that the request 120 has been received or sent, and/or determining a gender and/or age of the user.

For example, a user can navigate to a news web site (e.g., www.news.yahoo.com) and the news web site may have multiple topics or categories that a user can select to read news stories relevant to the selected topic or category. Examples of these topics or categories include Sports, Entertainment, Health, Finance, Travel, Weather, Local, etc. If, for example, the user has previously expressed interest in “Sports”, “Entertainment”, and “Health”, such as by clicking on these topics to read stories related to these topics, this information will be stored in the database 135 as part of the user activity data 130.

In one embodiment, the server computer 110 retrieves the user activity data 130 (e.g., that the user's interests are Sports, Entertainment, and Health) (step 215) from the database 135. In one embodiment, the server computer 110 identifies, using the stored user activity data 130, web content likely to be of interest to the user (step 220). The server computer 110 then dynamically generates a user specific web page including the identified web content (step 225) (and therefore based on the user activity data and, for example, not based on user settings for the web page input by the user). For example, the server computer 110 can modify the home page of a web site to display these sub-topics (Sports, Entertainment, and Health) and their corresponding news stories (e.g., instead of requiring the user to click on these categories to access the corresponding news stories). As another example, the server computer 110 can dynamically generate a user specific web page based on the user's location, such as by showing news related to that location or weather at that location. As yet another example, the server computer 110 can dynamically generate the user specific web page based on the user's age, such as by including age-specific content on the user specific web page.

The server computer 110 then transmits the user specific web page 140 to the user computing device 105 for display (step 230). The user specific web page is web content (e.g., a home page, a landing page, an advertisement) that is based on user browsing history and user actions. The web content can be a web page, a video, a media file, an advertisement, etc. The process is iterative, as shown with arrow 250. Thus, when a user views the user specific web page multiple times, the user specific web page may be refined each time because the user activity data changes as the user performs more actions on the web. Therefore, in one embodiment, steps 205-230 are repeated as the user's activities change/are updated over time.

In one embodiment, the server computer 110 is in communication with an advertisement server. The advertisement server may be a module or component within the server computer 110 or an external module or component or service or third party service. In one embodiment, the server computer 110 transmits a request for an advertisement to the advertisement server. In one embodiment, the request is for an advertisement related to one or more of the user activity data or web content. The advertisement server transmits an advertisement to the server computer 110, and the server computer 110 transmits the advertisement with the user specific web page.

Thus, the advertisement server can serve relevant advertisements based on the user activity data and/or the web content displayed in the user specific web page to the user. Alternatively, the advertisement server communicates directly with the user computing device 105 and transmits relevant advertisements to the user computing device 105 based on the displayed content (e.g., advertisements related to Entertainment, Sports, and/or Health). As these advertisements are relevant to the content that the user is viewing, the advertisements may generate a higher click-through rate than general advertisements.

Various monetization techniques or models may be used in connection with sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users

An “ad server” comprises a server that stores online advertisements for presentation to users. “Ad serving” refers to methods used to place online advertisements on websites, in applications, or other places where users are more likely to see them, such as during an online session or during computing platform use, for example. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

In one embodiment, the categories or topics displayed on the web page are displayed as tabs that the user can select. In one embodiment, the user specific web page includes a combination tab that is a combination of two or more topics or categories. For example, if a user is interested in Weather and Travel, the user specific web page can include a single tab for both weather and travel. Instead of typical web pages which require the user to select two separate tabs (e.g., one Weather tab and one Travel tab) and navigate to two separate web pages, when the user selects this single tab, information about both weather and travel are displayed. In another embodiment, a user can create a combination tab combining multiple topics or categories. This information can be stored as part of the user activity data 130 associated with the user.

In one embodiment, the user activity data 130 is determined not from user login information stored on the server computer 110 or from database 135 but rather from a cookie stored on the user computing device 105. For example, the user requests to receive a web page from the server computer 110. The server computer 110 retrieves from the user computing device 105 a cookie. The cookie tells the server computer 110 about the user activity data or interests of the user of the user computing device 105. The server computer 110 can then dynamically generate the user specific web page 140 based on the information retrieved from the cookie. As stated above, the user specific web page 140 is modified based on the user activity data/interests. Thus, the cookie can be used to determine the user activity data instead of data associated with user login information stored on database 135. In another embodiment, both a cookie and a database are used together to determine the user activity data.

In one embodiment, the server computer 110 utilizes data (e.g., obtained via the network 115) relating to one or more social networks of the user in one or more social networking sites such as FACEBOOK® to build or augment the stored data reflecting the user's past activities and interests. In one embodiment, the server computer 110 transmits the user specific web page to or shares it with a second user computing device operated by a second user that is socially connected to the user of the user computing device 105 in a social network site. In one embodiment, the server computer 110 transmits an alert to the second user that a user specific web page for the user is available. In another embodiment, the server computer 110 transmits the user specific web page to the second user computing device for display to the second user. In one embodiment, the manner in which the second user is notified of the user specific web page associated with the user is configured by the second user.

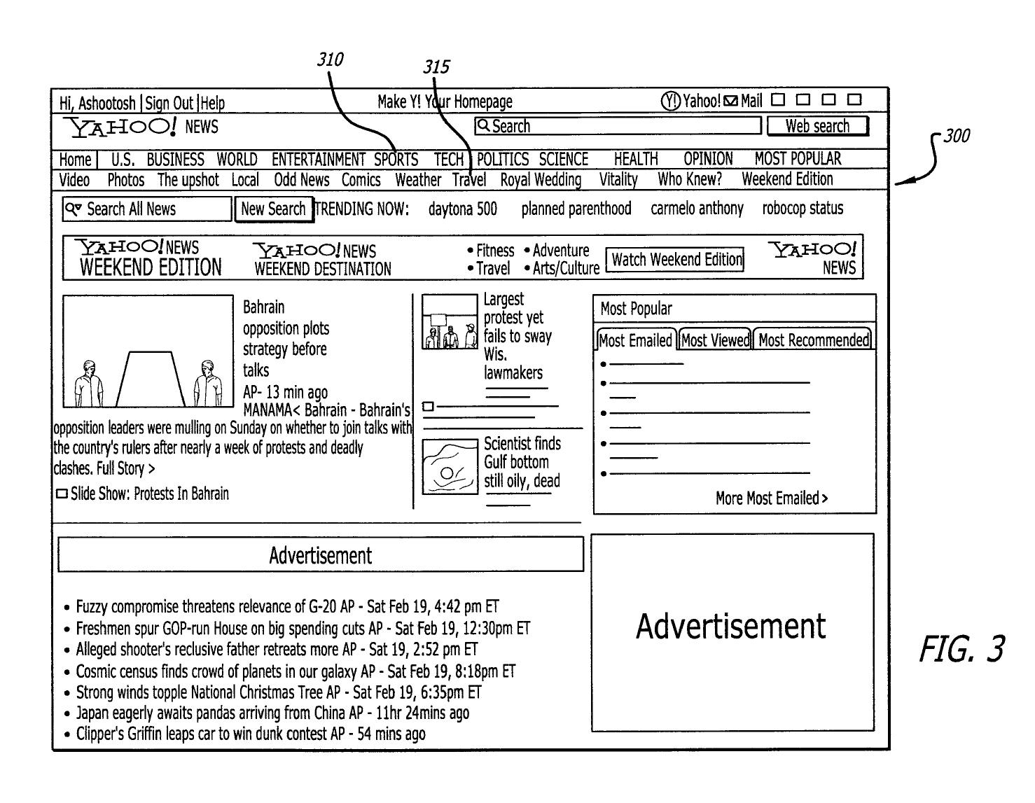

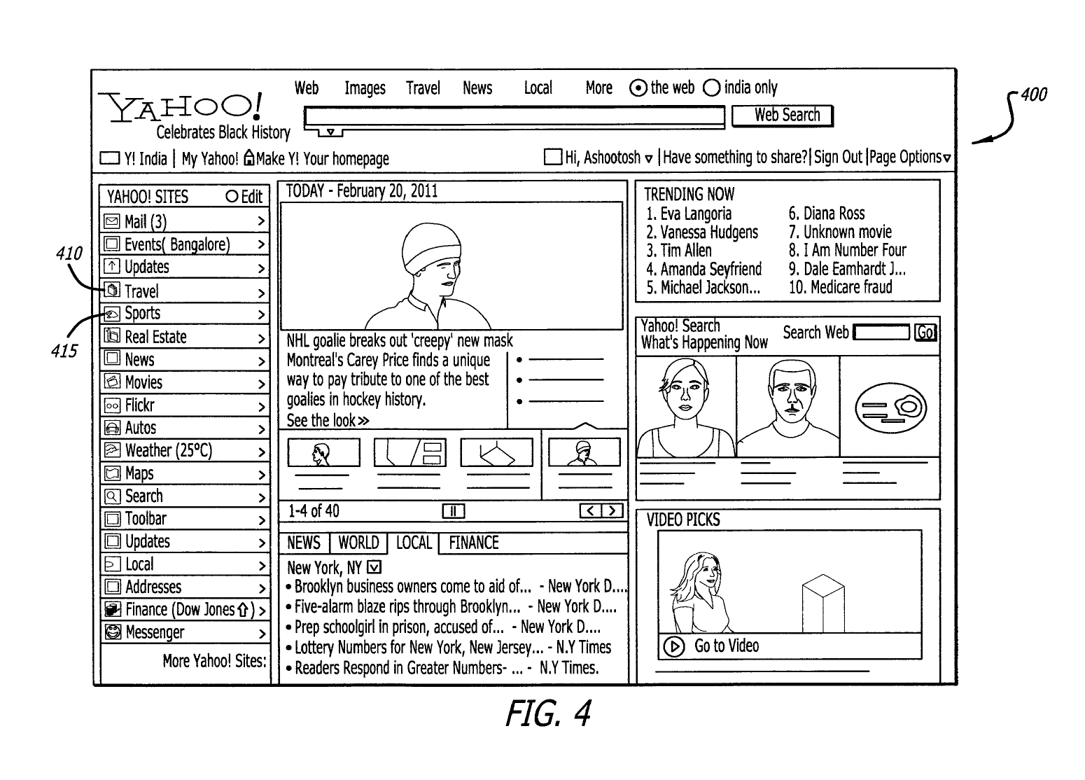

FIGS. 3 and 4 are embodiments of exemplary user interface screens 300, 400 displaying a typical web page. These web pages provide a user with a single experience regardless of the user's preferences or interests. Users can then navigate to a particular section, category, or topic (e.g., Sports and/or Travel) based on their interest or interests by clicking on the corresponding tab 310, 315, 410, 415.

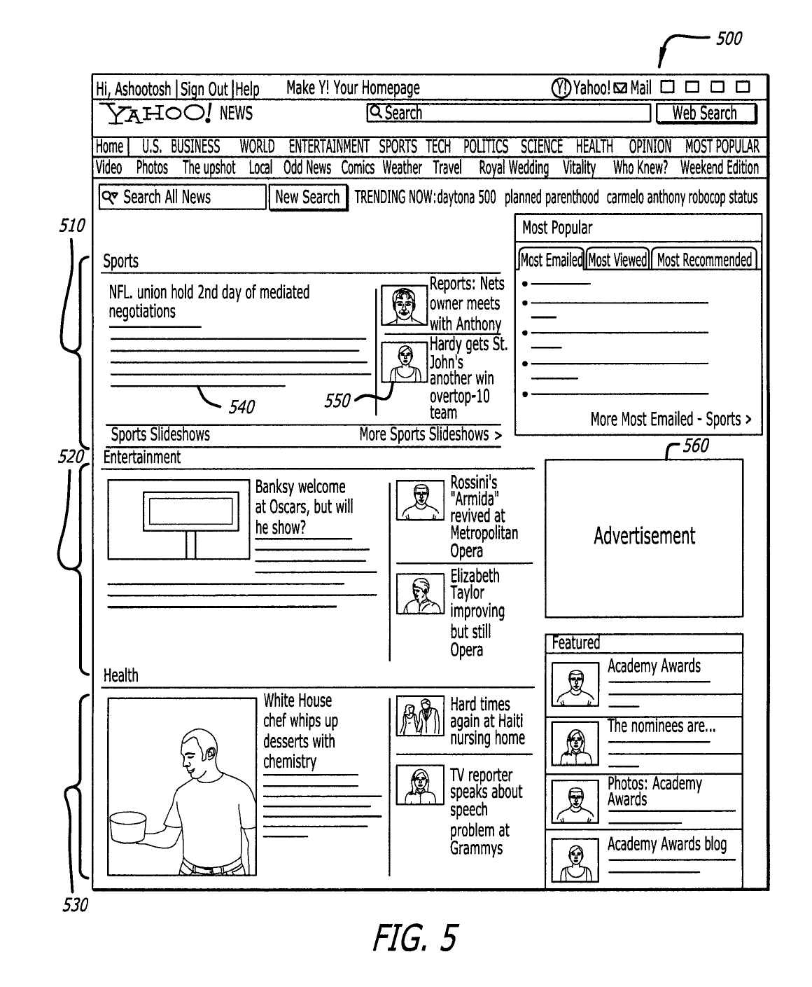

FIG. 5 is an embodiment of an exemplary user interface screen 500 showing a user specific web site having stories related to the user activity data when the user activity data includes Sports, Entertainment, and Health. There is a sports section 510 displayed, an Entertainment section 520 displayed, and a Health section 530 displayed. In one embodiment, each section 510, 520, 530 includes a headline story (e.g., headline story 540) and several secondary stories (e.g., secondary story 550). Unlike screen shots 300, 400, which show a general web page not tailored to any one specific user, the user specific web page 500 is focused on the user interests of the user as determined by a cookie stored on the user computing device 105 or as determined by the user activity data stored in the database 135. Thus, the user specific web page 500 is tailored to the user. In one embodiment, advertisements such as advertisement 560 are displayed on the user specific web page 500.

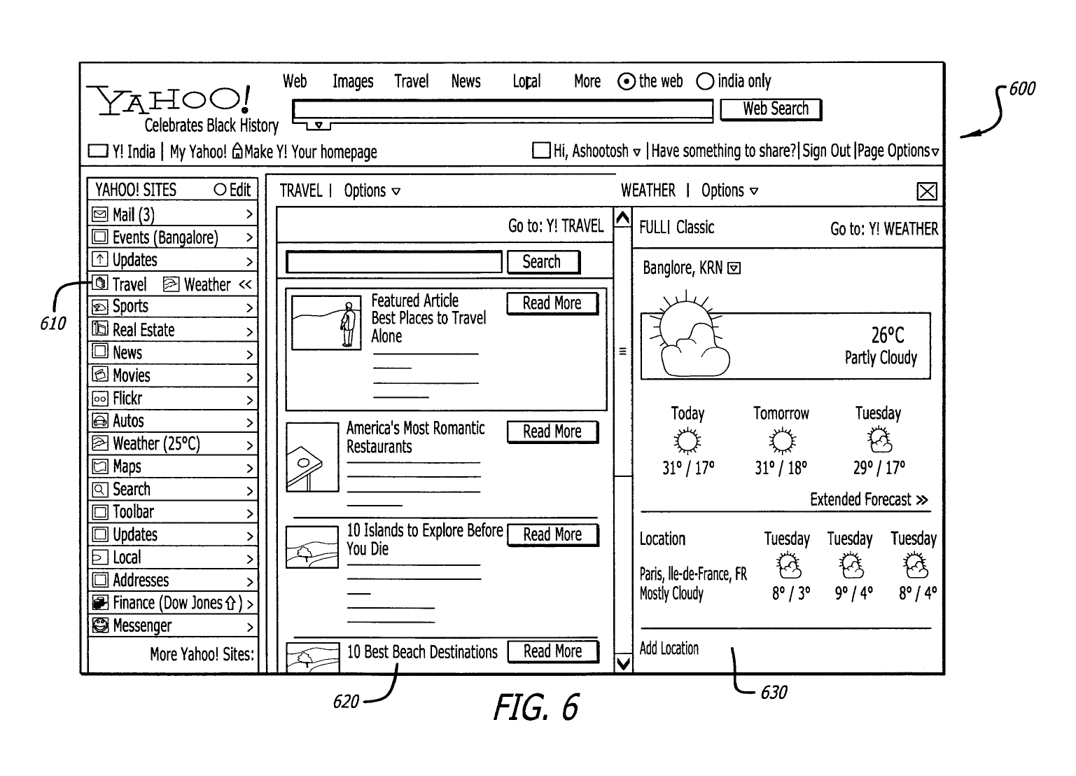

FIG. 6 is an embodiment of a user interface screen 600 of a user specific web page having a combination tab 610 of Travel and Weather. The combination tab 610 reflects the combination of Travel and Weather information because the system has identified through data collection of past user activity (as determined by a cookie or a database profile containing past activity data) that the user is likely to be interested in news or information relating to travel and weather. In screen shot 600, the user has selected the combination tab 610 and the web page is displaying a travel section 620 and a weather section 630. Although the sections 620, 630 are displayed side by side, any configuration of the sections 620, 630 is possible. In one embodiment, a travel section 620 is shown on the web page and the forecast is read out loud by the web page. In one embodiment, the weather shown in section 630 relates to the travel destinations shown in travel section 620. For example, the user may want to know what the weather is going to be like when the user travels to a travel destination. The user in this example would likely find the combination tab 610 useful. Although not shown, an advertisement related to the travel destinations shown in section 620 and/or the weather shown in section 630 may be displayed. In another embodiment, the sections 620, 630 may include links to other web sites based on the user activity data. The displaying of interesting sections or links to a user based on the user's interests without requiring the user to click on multiple tabs/links can lead to one or more of better engagement, higher time spent on the web page, and more targeted advertisements.

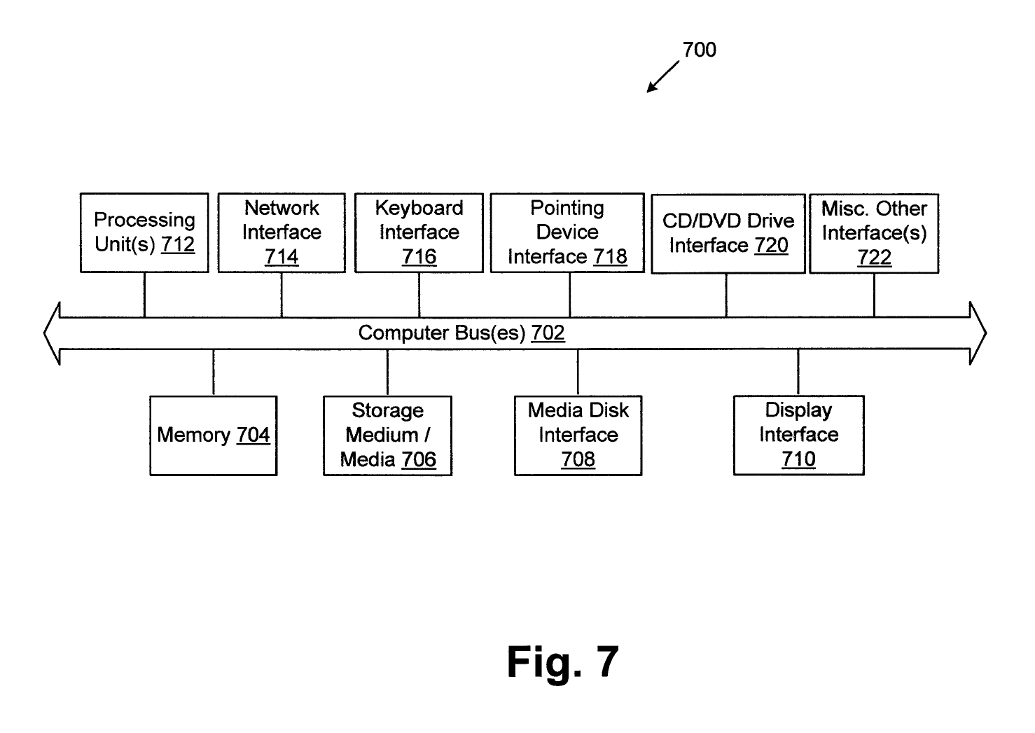

FIG. 7 is a block diagram illustrating an internal architecture of an example of a computer, such as server computer 110 and/or user computing device 105, in accordance with one or more embodiments of the present disclosure. A computer as referred to herein refers to any device with a processor capable of executing logic or coded instructions, and could be a server, personal computer, set top box, smart phone, pad computer or media device, to name a few such devices. As shown in the example of FIG. 7, internal architecture 700 includes one or more processing units (also referred to herein as CPUs) 712, which interface with at least one computer bus 702. Also interfacing with computer bus 702 are persistent storage medium/media 706, network interface 714, memory 704, e.g., random access memory (RAM), run-time transient memory, read only memory (ROM), etc., media disk drive interface 708 as an interface for a drive that can read and/or write to media including removable media such as floppy, CD-ROM, DVD, etc. media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code, and/or computer-executable process steps, incorporating functionality described herein, e.g., one or more of process flows described herein. CPU 712 first loads computer-executable process steps from storage, e.g., memory 704, storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage medium/media 706 is a computer readable storage medium(s) that can be used to store software and data, e.g., an operating system and one or more application programs. Persistent storage medium/media 706 can also be used to store device drivers, such as one or more of a digital camera driver, monitor driver, printer driver, scanner driver, or other device drivers, web pages, content files, playlists and other files. Persistent storage medium/media 706 can further include program modules and data files used to implement one or more embodiments of the present disclosure.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving, by a computer from a user computing device, a request to serve a web page;
retrieving, by the computer, stored user activity data of a user operating the user computing device, the stored user activity data based on interests of the user derived from actions taken by the user on web pages previously viewed by the user;
identifying, by the computer and using the stored user activity data, web content likely of interest to the user;
dynamically generating, by the computer, in response to the request, a user specific web page, the user specific web page comprising the identified web content; and
transmitting, by the computer, the user specific web page to the user computing device.

2. The method of claim 1, wherein the receiving a request to serve a web page further comprises receiving a request to serve a home page.

3. The method of claim 1, wherein the receiving a request to serve a web page further comprises receiving a request to serve a landing page.

4. The method of claim 1, wherein the retrieving of the stored user activity data further comprises retrieving a cookie from the user computing device, the cookie comprising the stored user activity data of the user.

5. The method of claim 1, wherein the retrieving of the stored user activity data further comprises accessing, by the computer, a database to obtain the stored user activity data associated with the user.

6. The method of claim 1, wherein the dynamically generating a user specific web page further comprises dynamically generating a combination tab associated with the user activity data, the combination tab comprising a tab on the web page associated with a plurality of stored activities of the stored user activity data.

7. The method of claim 1, wherein the retrieving of the stored user activity data comprises retrieving preferences that are based on user interactions with the web pages previously viewed by the user over a predetermined period of time.

8. The method of claim 1, wherein the dynamically generating the user specific web page further comprises dynamically generating the user specific web page based on a determined location of the user, the user specific web page comprising subject matter related to the determined location of the user.

9. The method of claim 1, wherein the dynamically generating the user specific web page further comprises dynamically generating the user specific web page based on a determined time of day that the request has been received.

10. The method of claim 1, wherein the dynamically generating the user specific web page further comprises dynamically generating the user specific web page based on a determined gender of the user, the user specific web page comprising subject matter related to the determined gender of the user.

11. The method of claim 1, wherein the dynamically generating the user specific web page further comprises dynamically generating the user specific web page based on a determined age of the user, the user specific web page comprising subject matter related to the determined age of the user.

12. The method of claim 1, wherein the transmitting of the user specific web page to the user computing device further comprises transmitting the user specific web page to a social connection of the user in a social network.

13. The method of claim 1, wherein the web content further comprises an advertisement, the advertisement being selected based upon the stored user activity data.

14. A non-transitory computer readable storage medium tangibly storing computer program instructions capable of being executed by a computer processor, the computer program instructions defining the steps of:
receiving, by a computer from a user computing device, a request to serve a web page;
retrieving, by the computer, stored user activity data of a user operating the user computing device, the stored user activity data based on interests of the user derived from actions taken by the user on web pages previously viewed by the user;
identifying, by the computer and using the stored user activity data, web content likely of interest to the user;
dynamically generating, by the computer, in response to the request, a user specific web page, the user specific web page comprising the identified web content; and
transmitting, by the computer, the user specific web page to the user computing device.

15. The non-transitory computer readable storage medium of claim 14, wherein the computer program instructions defining the step of retrieving the stored user activity data further comprises computer program instructions defining the step of retrieving a cookie from the user computing device, the cookie comprising the user activity data of the user.

16. The non-transitory computer readable storage medium of claim 14, wherein the computer program instructions defining the step of retrieving the stored user activity data further comprises computer program instructions defining the step of accessing, by the computer, a database to obtain the stored user activity data associated with the user.

17. The non-transitory computer readable storage medium of claim 14, wherein the computer program instructions defining the step of dynamically generating a user specific web page further comprises computer program instructions defining the step of dynamically generating a combination tab associated with the user activity data, the combination tab comprising a tab on the web page associated with a plurality of stored activities of the stored user activity data.

18. The non-transitory computer readable storage medium of claim 14, wherein the computer program instructions defining the step of retrieving the stored user activity data comprises computer program instructions defining the step of retrieving preferences that are based on user interactions with the web pages previously viewed by the user over a predetermined period of time.

19. The non-transitory computer readable storage medium of claim 14, wherein the computer program instructions defining the step of dynamically generating the user specific web page further comprises computer program instructions defining the step of dynamically generating the user specific web page based on a determined location of the user, the user specific web page comprising subject matter related to the determined location of the user.

20. The non-transitory computer readable storage medium of claim 14, wherein the computer program instructions defining the step of dynamically generating the user specific web page further comprises computer program instructions defining the step of dynamically generating the user specific web page based on a determined time of day that the request has been received.

21. The non-transitory computer readable storage medium of claim 14, wherein the computer program instructions defining the step of dynamically generating the user specific web page further comprises computer program instructions defining the step of dynamically generating the user specific web page based on a determined gender of the user, the user specific web page comprising subject matter related to the determined gender of the user.

22. The non-transitory computer readable storage medium of claim 14, wherein the computer program instructions defining the step of dynamically generating the user specific web page further comprises computer program instructions defining the step of dynamically generating the user specific web page based on a determined age of the user, the user specific web page comprising subject matter related to the determined age of the user.

23. The non-transitory computer readable storage medium of claim 14, wherein the computer program instructions defining the step of transmitting the user specific web page to the user computing device further comprises computer program instructions defining the step of transmitting the user specific web page to a social connection of the user in a social network.

24. A computer comprising:
a processor;
a storage medium for tangibly storing thereon program logic for execution by the processor, the program logic comprising:
receiving logic executed by the processor for receiving, from a user computing device, a request to serve a web page;
retrieving logic executed by the processor for retrieving stored user activity data of a user operating the user computing device, the stored user activity data based on interests of the user derived from actions taken by the user on web pages previously viewed by the user;
identifying, by the computer and using the stored user activity data, web content likely of interest to the user;
generating logic executed by the processor for dynamically generating, in response to the request, a user specific web page, the user specific web page comprising the identified web content; and
transmitting logic executed by the processor for transmitting the user specific web page to the user computing device.
